(19) United States
(12) Patent Application Publication
(10) Pub. No.: US 2026/0082295 A1
(43) Pub. Date: Mar. 19, 2026

(54) METHODS AND APPARATUSES FOR MOBILITY ENHANCEMENTS

(71) Applicant: Lenovo (Beijing) Limited, Beijing (CN)

(72) Inventors: Min Xu, Beijing (CN); Lianhai Wu, Beijing (CN); Jing Han, Beijing (CN); Ran Yue, Beijing (CN); Jie Hu, Beijing (CN)

(73) Assignee: Lenovo (Beijing) Limited, Beijing (CN)

(21) Appl. No.: 19/106,408

(22) PCT Filed: Sep. 9, 2022
(86) PCT No.: PCT/CN2022/118129

§ 371 Date: Feb. 25, 2025

(51) Int. Cl. H04W 36/14; H04B 7/185

(52) U.S. Cl. CPC H04W 36/142; H04B 7/18513

(57) ABSTRACT

The present application relates to methods and apparatuses for mobility enhancements. An embodiment of the present disclosure provides a user equipment (UE), comprising: a transceiver, and a processor coupled with the transceiver and configured to: receive a message associated with a moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value; determine the cell reference location of the moving cell or a UE-specific stop serving time value based on the message.

### TECHNICAL FIELD

The present disclosure relates to wireless communication, and particularly relates to methods and apparatuses for mobility enhancements.

### BACKGROUND OF THE INVENTION

The non-terrestrial network (NTN) network refers to networks, or segments of networks using radio frequency resources on board a satellite. The satellite in NTN may include low earth orbiting (LEO) satellites orbiting around the Earth, medium earth orbiting (MEO) satellites, geostationary earth orbiting (GEO) satellites with fixed location to the Earth, as well as highly elliptical orbiting (HEO) satellites. In some scenarios, the satellite in NTN may also include microsatellite platforms (a.k.a. Cube satellites) with limited size and power and low-density satellite constellations, which have restricted link budget and discontinuous coverage where the UE can remain long periods of time without being able to detect a satellite cell.

Due to the capability of LEO satellite beamforming, two kinds of NTN cells are defined. Quasi-earth-fixed cell is an NTN cell fixed with respect to a certain geographic area on the earth during a certain time duration, while an earth-moving cell is an NTN cell moving with respect to the earth with satellite movements.

The cell movement of the earth-moving cell is different from that of the quasi-earth-fixed cell, and there may be issues in IDLE or INACTIVE mode mobility in the earth-moving cell.

### SUMMARY

It is desirable to provide solutions for mobility enhancements in the earth-moving cell.

An embodiment of the present disclosure provides a user equipment (UE), comprising: a transceiver; and a processor coupled with the transceiver and configured to: receive a message associated with a moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value; determine the cell reference location of the moving cell or a UE-specific stop serving time value based on the message.

In some embodiments, the first configuration includes at least one of the following: movement information of the cell reference location; one or more additional cell reference locations; one or more location offsets associated with the cell reference location; a first indication indicating the cell reference location is variable; or a second indication indicating a reference location of a radio access network (RAN) node associated with the moving cell.

In some embodiments, the movement information of the cell reference location includes at least one of the following: a velocity of the cell reference location; a first epoch time value associated with the velocity of the cell reference location; a first validity duration associated with the velocity of the cell reference location; a variation vector of the velocity of the cell reference location; a second epoch time value associated with the variation vector of the velocity of the cell reference location; or a second validity duration associated with the variation vector of the velocity of the cell reference location.

In some embodiments, each of the one or more additional cell reference locations or each of one or more location offsets is associated with at least one of the following: a time value; an area; an angle; a reference signal receiving power (RSRP) value; a time value range; an area range; an angle range; or an RSRP value range.

In some embodiments, the processor is further configured to perform at least one of the following: determine the cell reference location based on the movement information of the cell reference location; determine the cell reference location as one of the one or more additional cell reference locations; determine the cell reference location by applying one of the one or more location offsets to the cell reference location; determine the cell reference location based on ephemeris of an RAN node; or determine the cell reference location as the reference location of the RAN node based on the second indication.

In some embodiments, the second configuration includes at least one of the following: a reference signal receiving power (RSRP) threshold; an RSRP variation threshold; or a time threshold.

In some embodiments, the processor is further configured to perform at least one of the following: calculate a distance between the UE and the cell reference location; calculate the distance between the UE and the cell reference location in response to an RSRP value being lower than the RSRP threshold; calculate the distance between the UE and the cell reference location in response to an RSRP variation being lower than the RSRP variation threshold; calculate the distance between the UE and the cell reference location in response to a round-trip time (RTT) value between the UE and an RAN node being larger than the time threshold; evaluate whether the distance between the UE and the cell reference location is shorter than a distance threshold; evaluate whether the distance between the UE and the cell reference location is shorter than the distance threshold in response to the RSRP value being lower than the RSRP threshold; evaluate whether the distance between the UE and the cell reference location is shorter than the distance threshold in response to the RSRP variation being lower than the RSRP variation threshold; or evaluate whether the distance between the UE and the cell reference location is shorter than the distance threshold in response to the RTT value between the UE and an RAN node being larger than the time threshold.

In some embodiments, the third configuration includes at least one of the following: one or more additional cell stop serving time values; one or more time offsets associated with the cell stop serving time value; a third indication indicating the cell stop serving time value is variable; or a cell stop serving time threshold.

In some embodiments, each of the one or more additional cell stop serving time values or each of the one or more time offsets associated with the cell stop serving time value is associated with at least one of the following: an area; an angle; an RSRP value; an area range; an angle range; or an RSRP value range.

In some embodiments, the processor is further configured to perform at least one of the following: determine the UE-specific stop serving time value as one of the one or more additional cell stop serving time values; determine the UE-specific stop serving time value by applying one of the one or more time offsets to the cell stop serving time value; determine the UE-specific stop serving time value based on the cell stop serving time value and cell coverage information of the moving cell; or determine the UE-specific stop serving time value in response to a RTT between the UE and an RAN node being larger than the cell stop serving time threshold.

In some embodiments, the fourth configuration includes an information element (IE) indicating the feeder link switch time value of the moving cell.

In some embodiments, the processor is further configured to: determine the UE-specific stop serving time value as an earlier one of the feeder link switch time value or the cell stop serving time value.

In some embodiments, the message includes a system information message or a dedicated signalling.

In some embodiments, the processor is further configured to: evaluate whether to perform a neighbour cell measurement procedure for cell selection or cell reselection based on the message.

Another embodiment of the present disclosure provides an RAN node, comprising: a transceiver; and a processor coupled with the transceiver and configured to: determine a message associated with a moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value; and transmit the message to a UE.

In some embodiments, the first configuration includes at least one of the following: movement information of the cell reference location; one or more additional cell reference locations; one or more location offsets associated with the cell reference location; a first indication indicating the cell reference location is variable; or a second indication indicating a reference location of an RAN node associated with the moving cell.

In some embodiments, the movement information of the cell reference location includes at least one of the following: a velocity of the cell reference location; a first epoch time value associated with the velocity of the cell reference location; a first validity duration associated with the velocity of the cell reference location; a variation vector of the velocity of the cell reference location; a second epoch time value associated with the variation vector of the velocity of the cell reference location; or a second validity duration associated with the variation vector of the velocity of the cell reference location.

In some embodiments, each of the one or more additional cell reference locations or each of one or more location offsets is associated with at least one of the following: a time value; an area; an angle; a reference signal receiving power (RSRP) value; a time value range; an area range; an angle range; or an RSRP value range.

In some embodiments, the second configuration includes at least one of the following: a reference signal receiving power (RSRP) threshold; an RSRP variation threshold; or a time threshold.

In some embodiments, the third configuration includes at least one of the following: one or more additional cell stop serving time values; one or more time offsets associated with the cell stop serving time value; a third indication indicating the cell stop serving time value is variable; or a cell stop serving time threshold.

In some embodiments, each of the one or more additional cell stop serving time values or each of the one or more time offsets associated with the cell stop serving time value is associated with at least one of the following: an area; an angle; an RSRP value; an area range; an angle range; or an RSRP value range.

In some embodiments, the fourth configuration includes an information element (IE) indicating the feeder link switch time value of the moving cell.

In some embodiments, the message includes a system information message or a dedicated signalling.

Yet another embodiment of the present disclosure provides a method performed by a UE, comprising: receiving a message associated with an moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value; determining the cell reference location of the moving cell or a UE-specific stop serving time value based on the message.

Still another embodiment of the present disclosure provides a method performed by an RAN node, comprising: determining a message associated with an moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value; and transmitting the message to a UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings.

These drawings depict only example embodiments of the application and are not therefore to be considered limiting of its scope.

FIG. 1 illustrates depicts an NTN network according to some embodiments of the present disclosure.

FIGS. 2A and 2B respectively illustrate two types of NTN cells according to some embodiments of the present disclosure.

FIG. 3 illustrates a method performed by a UE for mobility enhancements according to some embodiments of the present disclosure.

FIG. 4 illustrates a method performed by an RAN node for mobility enhancements according to some embodiments of the present disclosure.

FIG. 5 illustrates a simplified block diagram of an apparatus for mobility enhancements according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G new radio (NR), 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

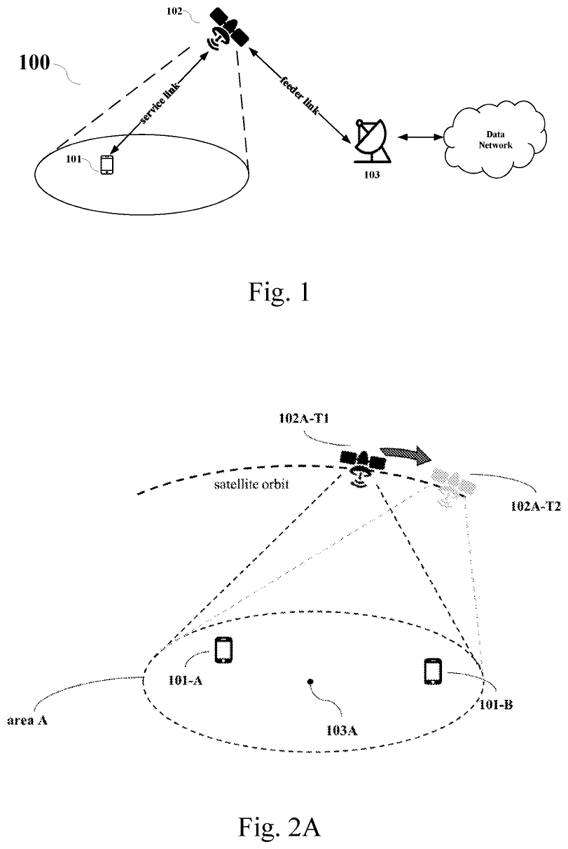

FIG. 1 depicts an NTN network according to some embodiments of the present disclosure.

As shown in FIG. 1, the NTN network 100 includes at least one UE 101 and at least one RAN nodes (e.g., satellite 102), or alternatively an unmanned aerial systems (UAS) platform 102. Although only one UE 101 and a satellite/UAS platform 102 are depicted in FIG. 1, it is contemplated that any number of UEs 101 and satellites/UAS platforms 102 may be included in the wireless communication system 100.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, modems), or the like. According to an embodiment of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101 includes wearable devices, such as smart watches, fitness bands, optical head-mounted displays, or the like. Moreover, the UE 101 may be referred to as subscriber units, mobiles, mobile stations, users, terminals, mobile terminals, wireless terminals, fixed terminals, subscriber stations, user terminals, a device, or by other terminology used in the art. The UE 101 may communicate directly with the satellite 102 via the service link.

Satellite 102 may include low earth orbiting (LEO) satellites, medium earth orbiting (MEO) satellites, geostationary earth orbiting (GEO) satellites, as well as highly elliptical orbiting (HEO) satellites. UAS platform(s) 102 may include unmanned aircraft systems (UAS) including tethered UAS and lighter than air UAS (LTA), Heavier than air UAS (HTA), and high altitude platforms UAS (HAPs). Hereinafter in the present disclosure, satellite 102 is used elaborate the technical solution. However, persons skilled in the art can know that the same technique may also be applied to the UAS platform(s).

Referring still to FIG. 1, the satellite 102 provides a geographic cell for serving UE 101 located in the geographic cell. In FIG. 1, UE 101 may be a normal mobile terminal 101, which can wirelessly communicate with the satellite/UAS platform 102 via a communications link, such as service link or radio link in accordance with a NR access technology (e.g., a NR-Uu interface). As also shown in FIG. 1, the satellite 102 also communicates with a gateway 103 or earth station via a communication link, which may be a feeder link or radio link in accordance with NR access technologies or other technologies. In accordance with various embodiments, the satellite 102 may be implemented with either a transparent or a regenerative payload. When the satellite carries a “transparent” payload, it performs only radio frequency filtering, frequency conversion and/or amplification of signals on board. Hence, the waveform signal repeated by the payload is un-changed. When a satellite carries a regenerative payload, in addition to performing radio frequency filtering, frequency conversion and amplification, it performs other signal processing functions such as demodulation/decoding, switching and/or routing, coding/decoding and modulation/demodulation on board as well. In other words, for a satellite with a regenerative payload (i.e., all or part of base station functions (e.g., a gNB, eNB, etc.) are implemented on board. Hereinafter in the present disclosure, satellite 102 may also be referred to as an RAN node 102, which may include a satellite with a regenerative payload or a satellite with a regenerative payload. The RAN node 102 may act as an access node, while in some other embodiments of the present disclosure, the satellite 102 may also act as a BS.

A typical terrestrial communication network includes one or more base stations (typically known as a “BS”) located on earth (i.e., not airborne or spaceborne), and each provides geographic radio coverage, and one or more UEs that can transmit and receive data within the radio coverage. In the terrestrial communication network, a BS and a UE can communicate with each other via a communication link, e.g., via a downlink radio frame from the BS to the UE or via an uplink radio frame from the UE to the BS.

Returning back to FIG. 1, the gateway 103 may be coupled to a data network such as, for example, the Internet, terrestrial public switched telephone network, mobile telephone network, or a private server network, etc. Gateway 103 and the satellite 102 communicate over a feeder link, which includes both a feeder uplink from the gateway 103 to the satellite 102 and a feeder downlink from the satellite 102 to the gateway 103. Although a single gateway 103 is shown, some implementations will include many gateways, such as five, ten, or more. One embodiment includes only one gateway. UE 101 and satellite 102 may communicate over a service link, which may include both an uplink from UE 101 to satellite 102 and a downlink from satellite 102 to UE 101.

In some embodiments, communication within the system of FIG. 1 follows a nominal roundtrip direction whereby data is received by gateway from data network (e.g., the Internet) and transmitted over a forward path to UE 101. In one example, communication over the forward path comprises transmitting the data from gateway to satellite 102 via uplink of the feeder link, through a first signal path on satellite, and from satellite 102 to UE 101 via downlink of the service link. Data can also be sent from UE 101 over a return path to gateway. In one example, communication over the return path may include transmitting the data from UE 101 to satellite 102 via uplink of the service link, through a second signal path on satellite 102, and from satellite 102 to gateway via downlink of the feeder link.

The wireless communication system 100 is compliant with any type of network that is capable of sending and receiving wireless communication signals. For example, the wireless communication system 100 is compliant with a wireless communication network, a cellular telephone network, a time division multiple access (TDMA)-based network, a code division multiple access (CDMA)-based network, an orthogonal frequency division multiple access (OFDMA)-based network, a LTE network, a 3GPP-based network, 3GPP 5G network, a satellite communications network, a high altitude platform network, and/or other communications networks.

In one implementation, the wireless communication system 100 is compliant with the NR of the 3GPP protocol, wherein the BS transmits using an OFDM modulation scheme on the DL and the UE 101 transmits on the UL using a single-carrier frequency division multiple access (SC-FDMA) scheme or OFDM scheme. More generally, however, the wireless communication system 100 may implement some other open or proprietary communication protocol, for example, WiMAX, among other protocols.

In other embodiments, the RAN node (such as satellite 102) may communicate using other communication protocols, such as the IEEE 802.11 family of wireless communication protocols. In some embodiments, the RAN node 102 may communicate over licensed spectrum, while in other embodiments the RAN node 102 may communicate over unlicensed spectrum. The present disclosure is not intended to be limited to the implementation of any particular wireless communication system architecture or protocol. In another embodiment, the RAN node 102 may communicate with the UE 101 using the 3GPP 5G protocols.

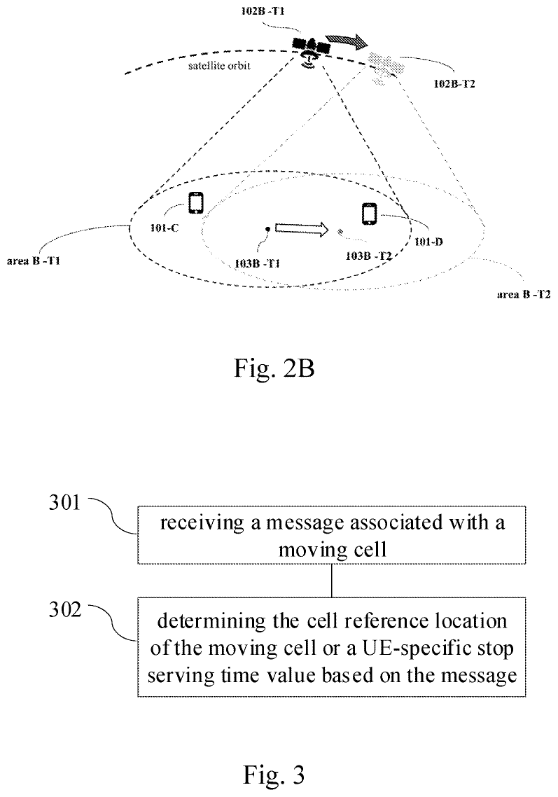

FIG. 2A and FIG. 2B illustrate two types of NTN cells according to some embodiments of the present disclosure.

FIG. 2A illustrates a quasi-earth-fixed cell, which may be an NTN cell fixed with respect to a certain geographic area on the earth during a certain time duration. For example, in FIG. 2A, at time T1, the RAN node (i.e. satellite 102A-T1) serves a cell with area A, and at time T2, the satellite moves to another location, which is represented as 102A-T2, and the satellite still serves the cell with area A. Accordingly, the reference point (i.e. reference point 103A) at time T1 and the reference point at time T2 are the same. In this scenario, the stop serving time is cell-specific, and is common for all UEs in the cell. For UE 101-A and UE 101-B, the stop serving time (or the stop serving time values) at time T1 (which may be represented to as: t-Service) and the stop serving time at time T2 may be identical.

FIG. 2B illustrates a moving cell, which may be an NTN cell moving with respect to the earth with satellite movements. The moving cell may also be referred to as an earth-moving cell, or an NTN earth-moving cell. In FIG. 2A, at time T1, the RAN node (i.e. satellite 102B-T1) serves a cell with an area (i.e. area B-T1), and at time T2, the RAN node serves a cell with another area (i.e. area B-T2). Accordingly, the reference point (i.e. reference point 103B-T1) at time T1 and the reference point (i.e. reference point 103B-T2) at time T2 are different. In this scenario, the stop serving time is UE-specific. For UE 101-C, the stop serving time at time T1 and the stop serving time at time T2 may be different. Similarly, for UE 101-D, the stop serving time at time T1, and the stop serving time at time T2 may also be different. Furthermore, the stop serving time for UE 101-C and that for UE 101-D may be different.

In 3GPP Rel-17 NR NTN work item, for quasi-earth-fixed cells, the IDLE or INACTIVE mode mobility enhancements (namely location-based cell reselection and timing-based cell reselection) are introduced. For example, in the 3GPP documents, such as section 5.2.4.2 in TS38.304 v17.1.0, the measurement rules for cell re-selection are defined as follows:

3GPP TS38.304 v17.1.0
5.2.4.2 Measurement rules for cell re-selection
Following rules are used by the UE to limit needed measurements:

| - | If the serving cell fulfils Srxlev > S_{IntraSearchP} and Squal > S_{IntraSearchQ}: | |
|---|---|---|
| | - | If distanceThresh is broadcasted in SIB19, and if UE supports location-based measurement |
| | | initiation and has obtained its location information: |
| | | - If the distance between UE and the serving cell reference location is shorter than |
| | | distanceThresh, the UE may not perform intra-frequency measurements; |
| | | - Otherwise, the UE shall perform intra-frequency measurements; |
| | - | Otherwise, the UE may not perform intra-frequency measurements; |
| - | Otherwise, the UE shall perform intra-frequency measurements. | |
| - | The UE shall apply the following rules for NR inter-frequencies and inter-RAT frequencies | |
| | which are indicated in system information and for which the UE has priority provided as defined | |
| | in 5.2.4.1: | |
| | - | For a NR inter-frequency or inter-RAT frequency with a reselection priority higher than the |
| | | reselection priority of the current NR frequency, the UE shall perform measurements of |
| | | higher priority NR inter-frequency or inter-RAT frequencies according to TS 38.133 [8]. |
| | - | For a NR inter-frequency with an equal or lower reselection priority than the reselection |
| | | priority of the current NR frequency and for inter-RAT frequency with lower reselection |
| | | priority than the reselection priority of the current NR frequency: |
| | | - If the serving cell fulfils Srxlev > S_{nonIntraSearchP} and Squal > S_{nonIntraSearchQ}: |

| | |
|---|---|
| - | If distanceThresh is broadcasted in SIB19, and if UE supports location-based |
| | measurement initiation and has valid UE location information: |

| - | If the distance between UE and the serving cell reference location is shorter than |
|---|---|
| | distanceThresh, the UE may choose not to perform measurements of NR |
| | inter-frequency cells of equal or lower priority, or inter-RAT frequency cells of |
| | lower priority; |
| - | Otherwise, the UE shall perform measurements of NR inter-frequency cells of |

equal or lower priority, or inter-RAT frequency cells of lower priority according
to TS 38.133 [8];

| | |
|---|---|
| - | Otherwise, the UE may choose not to perform measurements of NR inter-frequency |
| | cells of equal or lower priority, or inter-RAT frequency cells of lower priority; |

```
  - Otherwise, the UE shall perform measurements of NR inter-frequency cells of equal or
  lower priority, or inter-RAT frequency cells of lower priority according to TS 38.133 [8].
```

| | |
|---|---|
| - | If the UE supports relaxed measurement and relaxedMeasurement is present in SIB2, the UE |
| | may further relax the needed measurements, as specified in clause 5.2.4.9. |

If the t-Service of the serving cell is present in SIB19, UE shall perform intra-frequency,
inter-frequency or inter-RAT measurements before the t-Service, regardless of the distance between UE
and the serving cell reference location or whether the serving cell fulfils Srxlev > SIntraSearchP and
Squal > SIntraSearchQ, or Srxlev > SnonIntraSearchP and Squal > SnonIntraSearchQ and the exact
time to start measurement before t-Service is up to UE implementation. UE shall perform
measurements of higher priority NR inter-frequency or inter-RAT frequencies according to TS 38.133
[8] regardless of the remaining service time of the serving cell (i.e. time remaining until t-Service).

| NOTE: | When evaluating the distance between UE and the serving cell reference location, it's up |
|---|---|
| | to UE implementation to obtain UE location information. |

In general, for NTN quasi-earth-fixed cells, when the distance between the UE and its serving cell reference location (e.g., the cell center of the serving cell), or when the serving cell approaches its stop serving time, the UE may trigger neighbour cell measurement for cell reselection.

As explained in FIGS. 2A and 2B, for NTN quasi-earth-fixed cells, the stop serving time is cell-specific, while for the moving cells, the stop serving time is UE-specific, or location-specific. In other words, the stop serving time for the moving cells may be different for different UEs, or different for different locations. Therefore, the above IDLE or INACTIVE mode mobility enhancements for the NTN quasi-earth-fixed cells may not be applied for the moving cells.

In particular, for the moving cells, which are different from the quasi-earth-fixed cells in cell movement, there may be the following issues in IDLE or INACTIVE mode mobility.

Issue 1: How to indicate the cell reference location of a moving cell

In Rel-17 NR NTN, the reference location (which may be represented as: referenceLocation) of the serving cell is broadcasted in the system information block (SIB), such as SIB19, which is fixed for a quasi-earth-fixed cell before the stop serving time of the quasi-earth-fixed cell.

For a moving cell, whose reference location is moving over time, for a UE in the moving cell, frequently re-acquiring (e.g., the re-acquiring may be triggered by system information (SI) change) the reference location of the moving cell may cause more power consumption compared with a UE in a quasi-earth-fixed cell.

In some other cases, the reference location change may not trigger the SI change. Therefore, there is an issue regarding how to indicate the reference location of a moving cell to the UE.

Issue 2: When to calculate the distance between the UE and the reference location of the moving cell for cell reselection.

The location-based cell reselection of quasi-earth-fixed cells may be applied to the moving cells as well. Since the reference location of the moving cell is changing, frequent calculation or evaluation of the distance criterion may cause unnecessary UE power consumption. Therefore, there is an issue regarding when to calculate the distance between the UE and the reference location of the moving cell for cell reselection.

Issue 3: How to indicate the stop serving time for moving cells

In Rel-17 NR NTN, the stop serving time of a quasi-earth-fixed cell (which may be represented as: t-Service), is broadcasted in the system information block, e.g. SIB19, which is cell-specific and is common for all UEs in the cell. For a moving cell with a different serving duration for different locations, the cell stop serving time is location-specific and thus UE-specific. As a result broadcasting a single cell-specific t-Service may be inaccurate for the UE and may be difficult to use for the UE. Therefore, there is a need for indicating the UE-specific or location-specific cell stop serving time of a moving cell to the UE.

The timing-based cell reselection of quasi-earth-fixed cells may be applied to the moving cells as well, and the UE may need to determine when to evaluate the timing-based criterion based on absolute time or maintained timers.

Issue 4: How to indicate the feeder link switch time

In Rel-17 NR NTN, the feeder link switch issues for IDLE or INACTIVE mobility are de-prioritized due to time limit. Another reason is that, for quasi-earth-fixed cells, the cell stop serving time and the feeder link switch time are both cell-specific, and thus the network can configure the cell stop serving time (i.e.: t-Service), appropriately (i.e., as the earlier one of the feeder link switch time and the cell stop serving time). However the issues cannot be ignored or solved by network implementation for moving cells, considering that cell stop serving time for moving cells is UE-specific or location-specific while the feeder link switch time is cell-specific. Therefore, there is an issue regarding how to indicate the feeder link switch time of a moving cell to the UE.

The present disclosure proposes some solutions for solving the above issues. More specifically, the present disclosure proposes some solutions for the IDLE or INACTIVE mode mobility enhancements for UEs in moving cells.

### Solution 1

In this solution, in addition to the cell reference location which is broadcasted in the SIB, such as SIB19 (the cell reference location may be referred to as: referenceLocation), the serving RAN node may further indicate a first configuration associated with the cell reference location of a moving cell. The first configuration may be indicated by an SIB, such as SIB19, or other SIBs. Alternatively, the first configuration may be indicated by a dedicated signalling, such as RRC signaling. For example, when the UE transitions from the RRC_CONNECTED state to the RRC_IDLE state, the serving RAN node may indicate the first configuration in the RRC release signaling, i.e. RRC release message. The cell reference location of the moving cell may be represented as: referenceLocationInfo-v18xy-IEs, and the first configuration may include at least one of the following:
1. movement information of the cell reference location;
2. one or more additional cell reference locations;
3. one or more location offsets associated with the cell reference location;
4. a first indication indicating the cell reference location is variable; or
5. a second indication indicating a reference location of an RAN node associated with the moving cell.

The movement information of the cell reference location may include at least one of the following:
i. the drift of the cell reference location (which may be represented as: referenceLocationDrift) or the velocity of the cell reference location. The drift or the velocity may indicate the moving speed of the reference location, the moving direction of the reference location, or both.
ii. a first epoch time value (which may be represented as: epochTimeReferenceLocation), associated with the drift or velocity of the cell reference location.
iii. a first validity duration (which may be represented as: ValidityDurationReferenceLocation), associated with the drift or velocity of the cell reference location.
iv. the variation vector of the drift or velocity of the cell reference location (which may be represented as: referenceLocationDriftVariant), indicating the acceleration of the reference location, the moving direction of the reference location, or both.
v. a second epoch time value (which may be represented as: epochTimeReferenceLocation), associated with the drift or velocity of the cell reference location, the variation vector of the drift or velocity of the cell reference location, or both. In some embodiments, the first epoch time value associated with the drift or velocity of the cell reference location and the second epoch time value associated with the variation vector of the drift or velocity of the cell reference location may be different, while in some other embodiments, they may be the same.
vi. a second validity duration (which may be represented as: ValidityDurationReferenceLocation), associated with the drift or velocity of the cell reference location, or the variation vector of the drift or velocity of the cell reference location, or both. In some embodiments, the first validity duration associated with the drift or velocity of the cell reference location and the second validity duration associated with the variation vector of the drift or velocity of the cell reference location may be different, while in some other embodiments, they may be the same.

Regarding the one or more additional cell reference locations (which may be represented as: referenceLocation1, referenceLocation2, . . . ), each additional cell reference location may be associated with a condition. In the case that the associated condition is fulfilled, the UE may determine the UE-specific cell reference location of the moving cell as the additional cell reference location whose associated condition being fulfilled.

For example, for the first reference location, i.e. referenceLocation1, the condition may be associated with at least one of the following:
i. a time value (which may be represented as: t-ReferenceLocation1); the condition may include: whether the current time is equal to (later than, earlier than, not later than, or not earlier than, etc.) the time value or not;
ii. an area (which may be represented as: area-ReferenceLocation1); the condition may include: whether the location of the UE is within the area or not;
iii. an angle (which may be represented as: angle-ReferenceLocation1), which may be an elevation angle between the UE and the RAN node (e.g. a satellite), other types of angles may also be used; the condition may include: whether the current angle of the UE is equal to (larger than, smaller than, not larger than, or not smaller than, etc.) the angle or not;
iv. an RSRP value (which may be represented as: rsrp-ReferenceLocation1); the condition may include: whether the current RSRP value of the moving cell is equal to (larger than, smaller than, not larger than, or not smaller than, etc.) the RSRP value or not;
v. a time value range (which may be represented as: t-ReferenceLocation1); the condition may include: whether the current time is within the time value range or not;
vi. an area range (which may be represented as: area-ReferenceLocation1; the condition may include: whether the location of the UE is within the area range or not;
vii. an angle range (which may be represented as: angle-ReferenceLocation1); the condition may include: whether the current angle of the UE is within the angle range or not; or
viii. an RSRP value range (which may be represented as: rsrp-ReferenceLocation1); the condition may include: whether the current RSRP value of the moving cell is within the RSRP value range or not.

In some other cases, the condition may be associated with more than one of the above parameters. For example, the condition may be associated with a time value and an area, in this case, the condition may include: condition 1) whether the current time is equal to (later than, earlier than, not later than, or not earlier than, etc.) the time value or not; and condition 2) whether the location of the UE is within the area or not. That is, only when both condition 1) and condition 2) are fulfilled, the condition is considered as fulfilled. Alternatively, the condition may include: condition 1) whether the current time is equal to (later than, earlier than, not later than, or not earlier than, etc.) the time value or not; or condition 2) whether the location of the UE is within the area or not. That is, when one of the condition 1) and condition 2) is fulfilled, the condition is considered as fulfilled. The condition associated with other number of parameters may be applied similarly.

Regarding the one or more offsets to the cell reference location (which may be represented as: offset1-ReferenceLocation, offset2-ReferenceLocation, . . . ), each offset may also be associated with a condition. In the case that the associated condition is fulfilled, the UE may apply the corresponding offset to the reference location of the moving cell (which may be broadcasted in the SIB), and determine the UE-specific reference location of the moving cell as the reference location of the moving cell (which may be broadcasted in the SIB) with the corresponding offset.

For example, for the first offset, i.e. offset1-ReferenceLocation, the condition may be associated with at least one of the following:
i. a time value (which may be represented as: t-Offset1-ReferenceLocation); the condition may include: whether the current time value is equal to (later than, earlier than, not later than, or not earlier than, etc.) than the time value or not;
ii. an area (which may be represented as: area-Offset1-ReferenceLocation); the condition may include: whether the location of the UE is within the area or not;
iii. an angle (which may be represented as: angle-Offset1-ReferenceLocation), which may be an elevation angle between the UE and the RAN node (e.g. a satellite), other types of angles may also be used; the condition may include: whether the current angle of the UE is equal to (larger than, smaller than, not larger than, or not smaller than, etc.) the angle or not;
iv. an RSRP value (which may be represented as: rsrp-Offset1-ReferenceLocation); the condition may include: whether the current RSRP value of the moving cell is equal to (larger than, smaller than, not larger than, or not smaller than, etc.) the RSRP value or not;
v. a time value range (which may be represented as: t-Offset1-ReferenceLocation); the condition may include: whether the current time is within the time value range or not;
vi. an area range (which may be represented as: area-Offset1-ReferenceLocation); the condition may include: whether the location of the UE is within the area range or not;
vii. an angle range (which may be represented as: angle-Offset1-ReferenceLocation); the condition may include: whether the current angle of the UE is within the angle range or not; or
viii. an RSRP value range (which may be represented as: rsrp-Offset1-ReferenceLocation); the condition may include: whether the current RSRP value of the moving cell is within the RSRP value range or not.

In some other cases, the condition may be associated with more than one parameter. For example, the condition may be associated with a time value and an area, in this case, the condition may include: condition 1) whether the current time value is equal to (later than, earlier than, not later than, or not earlier than, etc.) the time value or not; and condition 2) whether the location of the UE is within the area or not. That is, only when both condition 1) and condition 2) are fulfilled, the condition is considered as fulfilled. Alternatively, the condition may include: condition 1) whether the current time value is equal to (later than, earlier than, not later than, or not earlier than, etc.) the time value or not; or condition 2) whether the location of the UE is within the area or not. That is, when one of condition 1) and condition 2) is fulfilled, the condition is considered as fulfilled. The condition associated with other number of parameters may be applied similarly.

Regarding the first indication indicating the cell reference location is variable (which may be represented as: referenceLocationChange), it may indicate that the cell reference location is moving, or is changing over time, etc.

Regarding the second indication indicating a reference location of an RAN node associated with the moving cell (which may be represented as: referenceLocationAsSat), it may indicate the satellite location as the cell reference location, the second indication may include three-dimensional coordinates of the satellite location, which may be different from the reference location of the moving cell (such as reference location 103A in FIG. 2A), which may be two-dimensional coordinates.

Based on the first configuration, the UE may perform at least one of the following:
determine that the serving cell is a moving cell, for example, an earth-moving cell, an NTN earth-moving cell, or the like.
determine the cell reference location and the movement of the cell reference location based on the movement information of the cell reference location;
determine the cell reference location as one of the one or more additional cell reference locations based on the associated condition;
apply one offset among the one or more location offsets associated with the cell reference location to the cell reference location based on the associated condition;
determine the cell reference location based on UE implementation in the case that the UE receives the first indication indicating the cell reference location is variable, for example, the UE may determine the cell reference location based on the ephemeris of a satellite; or
determine the location of the RAN node (e.g. a satellite) as indicated by the second indication, and may determine the distance between the UE and the RAN node. The UE may use the distance between the UE and the RAN node for the distance-based evaluation. For example, the UE may evaluate the distance-based criterion as explained in solution 2 below.

In some embodiments, an example of SIB 19 indicating the first configuration in 3GPP specification may be as follows:

3GPP TS38.331
- SIB19
SIB19 contains satellite assistance information.
SIB19 information element
-- ASN1START
-- TAG-SIB19-START
SIB19-r17 ::= SEQUENCE {

| | | | |
|---|---|---|---|
| ntn-Config-r17 | NTN-Config-r17 | OPTIONAL, | -- Need R |
| t-Service-r17 | INTEGER (0..549755813887) | OPTIONAL, | -- Need R |
| referenceLocation-r17 | ReferenceLocation-r17 | OPTIONAL, | -- Need R |
| distance Thresh-r17 | INTEGER(0..65525) | OPTIONAL, | -- Need R |
| ntn-NeighCellConfigList-r17 | NTN-NeighCellConfigList-r17 | OPTIONAL, | -- Need R |

| | | |
|---|---|---|
| lateNonCriticalExtension | OCTET STRING | OPTIONAL, |
| nonCriticalExtension | referenceLocationInfo-v18xy-IEs | OPTIONAL, |

...
}

| | | | |
|---|---|---|---|
| NTN-NeighCellConfigList-r17 | ::= SEQUENCE | (SIZE(1..maxCellNTN-r17)) | OF |

NTN-NeighCellConfig-r17

| NTN-NeighCellConfig-r17 ::= | SEQUENCE { | | |
|---|---|---|---|
| ntn-Config-r17 | NTN-Config-r17 | OPTIONAL, | -- Need R |
| carrierFreq-r17 | ARFCN-ValueNR | OPTIONAL, | -- Need R |
| physCellId-r17 | PhysCellId | OPTIONAL | -- Need R |

}
//Option1-1//

| referenceLocationInfo-v18xy-IEs ::= | SEQUENCE { | | |
|---|---|---|---|
| referenceLocationDrift | INTEGER(xx..yy) | OPTIONAL, | -- Need R |
| referenceLocationDriftVariant | INTEGER(xx..yy) | OPTIONAL, | -- Need R |
| epochTimeReferenceLocation | EpochTime-r17 | OPTIONAL, | -- Need R |
| ValidityDurationReferenceLocation | ENUMERATED{xx..yy } | OPTIONAL, | -- Need R |

| | | |
|---|---|---|
| nonCriticalExtension | OCTET STRING | OPTIONAL, |

...
}
//Option1-2//

| referenceLocationInfo-v18xy-IEs ::= | SEQUENCE { | | |
|---|---|---|---|
| referenceLocation1 | ReferenceLocation-r17 | OPTIONAL, | -- Need R |
| t-ReferenceLocation1 | INTEGER(xx..yy) | OPTIONAL, | -- Need R |
| area-ReferenceLocation1 | OCTET STRING | OPTIONAL, | -- Need R |
| angle-ReferenceLocation1 | INTEGER(xx..yy) | OPTIONAL, | -- Need R |
| rsrp-ReferenceLocation1 | RSRP-Range | OPTIONAL, | -- Need R |
| referenceLocation2 | ReferenceLocation-r17 | OPTIONAL, | -- Need R |
| t-ReferenceLocation2 | INTEGER(xx..yy) | OPTIONAL, | -- Need R |
| area-ReferenceLocation2 | OCTET STRING | OPTIONAL, | -- Need R |
| angle-ReferenceLocation2 | INTEGER(xx..yy) | OPTIONAL, | -- Need R |
| rsrp-ReferenceLocation2 | RSRP-Range | OPTIONAL, | -- Need R |

| | | |
|---|---|---|
| nonCriticalExtension | OCTET STRING | OPTIONAL, |

...
}
//Option1-3//

| referenceLocationInfo-v18xy-IEs ::= | SEQUENCE { | | |
|---|---|---|---|
| offset1-ReferenceLocation | OCTET STRING | OPTIONAL, | -- Need R |
| t-Offset1-ReferenceLocation | INTEGER(xx..yy) | OPTIONAL, | -- Need R |
| area-Offset1-ReferenceLocation | OCTET STRING | OPTIONAL, | -- Need R |
| angle-Offset1-ReferenceLocation | INTEGER(xx..yy) | OPTIONAL, | -- Need R |
| rsrp-Offset1-ReferenceLocation | RSRP-Range | OPTIONAL, | -- Need R |
| offset2-ReferenceLocation | OCTET STRING | OPTIONAL, | -- Need R |
| t-Offset2-ReferenceLocation | INTEGER(xx..yy) | OPTIONAL, | -- Need R |
| area-Offset2-ReferenceLocation | OCTET STRING | OPTIONAL, | -- Need R |
| angle-Offset2-ReferenceLocation | INTEGER(xx..yy) | OPTIONAL, | -- Need R |
| rsrp-Offset2-ReferenceLocation | RSRP-Range | OPTIONAL, | -- Need R |

| | | |
|---|---|---|
| nonCriticalExtension | OCTET STRING | OPTIONAL, |

...
}
//Option1-4//

| referenceLocationInfo-v18xy-IEs ::= | SEQUENCE { | | |
|---|---|---|---|
| referenceLocationChange | BOOLEAN | OPTIONAL, | -- Need R |

| | | |
|---|---|---|
| nonCriticalExtension | OCTET STRING | OPTIONAL, |

...
}
//Option1-5//

| referenceLocationInfo-v18xy-IEs ::= | SEQUENCE { | | |
|---|---|---|---|
| referenceLocationAsSat | BOOLEAN | OPTIONAL, | -- Need R |
| referenceLocationSat | OCTET STRING | OPTIONAL, | -- Need R |

| | | |
|---|---|---|
| nonCriticalExtension | OCTET STRING | OPTIONAL, |

...
}
-- TAG-SIB19-STOP
-- ASN1STOP

In some other embodiments, the RRC release message indicating the first configuration in 3GPP documents may be as follows:

```
-  RRCRelease
The RRCRelease message is used to command the release of an RRC connection or the suspension of the
RRC connection.
  1> Signalling radio bearer: SRB1
  2> RLC-SAP: AM
  3> Logical channel: DCCH
  4> Direction: Network to UE
RRCRelease message
-- ASNISTART
-- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| RRCRelease-IEs ::= | SEQUENCE { | |
|---|---|---|
| redirectedCarrierInfo | RedirectedCarrierInfo | OPTIONAL, -- Need N |
| cellReselectionPriorities | CellReselectionPriorities | OPTIONAL, -- Need R |
| suspendConfig | SuspendConfig OPTIONAL, | -- Need R |

| | |
|---|---|
| deprioritisationReq | SEQUENCE { |
| deprioritisationType | ENUMERATED {frequency, nr}, |
| deprioritisationTimer | ENUMERATED {min5, min10, min15, min30} |

}
OPTIONAL, -- Need N

| | | |
|---|---|---|
| lateNonCriticalExtension | OCTET STRING | OPTIONAL, |
| nonCriticalExtension | RRCRelease-v1540-IEs | OPTIONAL |

}

| RRCRelease-v1540-IEs ::= | SEQUENCE { | |
|---|---|---|
| waitTime | RejectWaitTime | OPTIONAL, -- Need N |
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, -- Need N |

| | | |
|---|---|---|
| measIdleConfig-r16 | SetupRelease {MeasIdleConfigDedicated-r16} | OPTIONAL, |

-- Need M

| | | |
|---|---|---|
| nonCriticalExtension | RRCRelease-v1650-IEs | OPTIONAL |

}

| RRCRelease-v1650-IEs ::= | SEQUENCE { | |
|---|---|---|
| mpsPriorityIndication-r16 | ENUMERATED {true } | OPTIONAL, -- Cond |

Redirection2

| | | |
|---|---|---|
| nonCriticalExtension | RRCRelease-v1710-IEs | OPTIONAL |

}

| RRCRelease-v1710-IEs ::= | SEQUENCE { | |
|---|---|---|
| noLastCellUpdate-r17 | ENUMERATED {true} | OPTIONAL, -- Need S |
| nonCriticalExtension | RRCRelease-v18xy-IEs | OPTIONAL |

}

| RRCRelease-v18xy-IEs ::= | SEQUENCE { | |
|---|---|---|
| referenceLocationInfo-r18 | referenceLocationInfo-v18xy-IEs | OPTIONAL, |
| nonCriticalExtension | SEQUENCE { } | OPTIONAL |

}
...
//Option1-1//

| referenceLocationInfo-v18xy-IEs ::= | SEQUENCE { | | |
|---|---|---|---|
| referenceLocationDrift | INTEGER(xx..yy) | OPTIONAL, | -- Need R |
| referenceLocationDrift Variant | INTEGER(xx..yy) | OPTIONAL, | -- Need R |
| epochTimeReferenceLocation | EpochTime-r17 | OPTIONAL, | -- Need R |
| ValidityDurationReferenceLocation | ENUMERATED{xx..yy} | OPTIONAL, | -- Need R |

| | | |
|---|---|---|
| nonCriticalExtension | OCTET STRING | OPTIONAL, |

...
}
//Option1-2//
referenceLocationInfo-v18xy-IEs ::= SEQUENCE {

| | | | |
|---|---|---|---|
| referenceLocation1 | ReferenceLocation-r17 | OPTIONAL, | -- Need R |
| t-ReferenceLocation1 | INTEGER(xx..yy) | OPTIONAL, | -- Need R |
| area-ReferenceLocation1 | OCTET STRING | OPTIONAL, | -- Need R |
| angle-ReferenceLocation1 | INTEGER(xx..yy) | OPTIONAL, | -- Need R |
| rsrp-ReferenceLocation1 | RSRP-Range | OPTIONAL, | -- Need R |
| referenceLocation2 | ReferenceLocation-r17 | OPTIONAL, | -- Need R |
| t-ReferenceLocation2 | INTEGER(xx..yy) | OPTIONAL, | -- Need R |
| area-ReferenceLocation2 | OCTET STRING | OPTIONAL, | - Need R |
| angle-ReferenceLocation2 | INTEGER(xx..yy) | OPTIONAL, | -- Need R |
| rsrp-ReferenceLocation2 | RSRP-Range | OPTIONAL, | -- Need R |

| | | |
|---|---|---|
| nonCriticalExtension | OCTET STRING | OPTIONAL, |

...
}
//Option1-3//

| referenceLocationInfo-v18xy-IEs ::= | SEQUENCE { | | |
|---|---|---|---|
| offset1-ReferenceLocation | OCTET STRING | OPTIONAL, | -- Need R |
| t-Offset1-ReferenceLocation | INTEGER(xx..yy) | OPTIONAL, | -- Need R |
| area-Offset1-ReferenceLocation | OCTET STRING | OPTIONAL, | -- Need R |
| angle-Offset1-ReferenceLocation | INTEGER(xx..yy) | OPTIONAL, | -- Need R |
| rsrp-Offset1-ReferenceLocation | RSRP-Range | OPTIONAL, | -- Need R |
| offset2-ReferenceLocation | OCTET STRING | OPTIONAL, | -- Need R |
| t-Offset2-ReferenceLocation | INTEGER(xx..yy) | OPTIONAL, | -- Need R |
| area-Offset2-ReferenceLocation | OCTET STRING | OPTIONAL, | -- Need R |
| angle-Offset2-ReferenceLocation | INTEGER(xx..yy) | OPTIONAL, | -- Need R |
| rsrp-Offset2-ReferenceLocation | RSRP-Range | OPTIONAL, | -- Need R |

| | | |
|---|---|---|
| nonCriticalExtension | OCTET STRING | OPTIONAL, |

...
}
//Option1-4//

| referenceLocationInfo-v18xy-IEs ::= | SEQUENCE { | | |
|---|---|---|---|
| referenceLocationChange | BOOLEAN | OPTIONAL, | -- Need R |

| | | |
|---|---|---|
| nonCriticalExtension | OCTET STRING | OPTIONAL, |

...
}
//Option1-5//

| referenceLocationInfo-v18xy-IEs ::= | SEQUENCE { | | |
|---|---|---|---|
| referenceLocationAsSat | BOOLEAN | OPTIONAL, | -- Need R |
| referenceLocationSat | OCTET STRING | OPTIONAL, | -- Need R |

| | | |
|---|---|---|
| nonCriticalExtension | OCTET STRING | OPTIONAL, |

...
}
-- TAG-SIB19-STOP
-- ASN1STOP

### Solution 2

In this solution, in addition to the distance threshold of neighbour cell measurement triggering (which may be represented to as: distanceThresh), the serving RAN node may further indicate a second configuration associated with distance metric evaluation, which may be used to evaluate the distance-based criterion for a moving cell. The second configuration may be indicated by an SIB, such as SIB19, or other SIBs. Alternatively, the second configuration may be indicated by a dedicated signalling, such as RRC signaling. For example, when the UE transitions from the RRC_CONNECTED state to the RRC_IDLE state, the serving RAN node may indicate the second configuration in the RRC signaling, e.g. RRC release signaling. The second configuration associated with distance metric evaluation may be represented as: distanceThreshConfig, and may include at least one of the following:
1. a RSRP threshold (which may be represented as: rsrp-DistanceThresh);
2. an RSRP variation threshold (which may be represented as: delta-RSRP-DistanceThresh); or
3. a time threshold (which may be represented as: ta-DistanceThresh).

Based on the second configuration, the UE may perform at least one of the following:
calculate a distance between the UE and the cell reference location;
calculate the distance between the UE and the cell reference location in response to an RSRP value of the moving cell being lower than the RSRP threshold (i.e. rsrp-DistanceThresh);
calculate the distance between the UE and the cell reference location in response to an RSRP variation being lower than the RSRP variation threshold (i.e. delta-RSRP-DistanceThresh);
calculate the distance between the UE and the cell reference location in response to a RTT value between the UE and an RAN node being larger than the time threshold (i.e. ta-DistanceThresh). In some other cases, when the timing advance (or the total timing advance) or the UE-specific timing advance (the timing advance or the UE-specific timing advance may be calculated by the UE or maintained by the UE) is larger than the time threshold, the UE may calculate the distance between the UE and the cell reference location.
evaluate whether the distance between the UE and the cell reference location is shorter than a distance threshold (i.e. distanceThresh);
evaluate whether the distance between the UE and the cell reference location is shorter than the distance threshold in response to the RSRP value of the moving cell being lower than the RSRP threshold (i.e. rsrp-DistanceThresh);
evaluate whether the distance between the UE and the cell reference location is shorter than the distance threshold in response to the RSRP variation being lower than the RSRP variation threshold (i.e. delta-RSRP-DistanceThresh); or
evaluate whether the distance between the UE and the cell reference location is shorter than the distance threshold in response to the RTT value between the UE and an RAN node being larger than the time threshold (i.e. ta-DistanceThresh). In some other cases, when the timing advance (or the total timing advance) or the UE-specific timing advance (the timing advance or the UE-specific timing advance may be calculated by the UE or maintained by the UE), is larger than the time threshold, the UE may evaluate whether the distance between the UE and the cell reference location.

In some embodiments, an example of SIB 19 indicating the second configuration in 3GPP specification may be as follows:

3GPP TS38.331
- SIB19
SIB19 contains satellite assistance information.
SIB19 information element
-- ASN1START
-- TAG-SIB19-START
SIB19-r17 ::= SEQUENCE {

| | | | |
|---|---|---|---|
| ntn-Config-r17 | NTN-Config-r17 | OPTIONAL, | -- Need R |
| t-Service-r17 | INTEGER (0..549755813887) | OPTIONAL, | -- Need R |
| referenceLocation-r17 | ReferenceLocation-r17 | OPTIONAL, | -- Need R |
| distanceThresh-r17 | INTEGER(0..65525) | OPTIONAL, | -- Need R |
| ntn-NeighCellConfigList-r17 | NTN-NeighCellConfigList-r17 | OPTIONAL, | -- Need R |

| | | |
|---|---|---|
| lateNonCriticalExtension | OCTET STRING | OPTIONAL, |

| | |
|---|---|
| nonCriticalExtension | distanceThreshConfig-v18xy-IEs OPTIONAL, |

}

| | | | |
|---|---|---|---|
| NTN-NeighCellConfigList-r17 | ::= SEQUENCE | (SIZE(1..maxCellNTN-r17)) | OF |

NTN-NeighCellConfig-r17

| NTN-NeighCellConfig-r17 ::= | SEQUENCE { | | |
|---|---|---|---|
| ntn-Config-r17 | NTN-Config-r17 | OPTIONAL, | -- Need R |
| carrierFreq-r17 | ARFCN-ValueNR | OPTIONAL, | -- Need R |
| physCellId-r17 | PhysCellId | OPTIONAL | -- Need R |

}
distanceThreshConfig-v18xy-IEs ::= SEQUENCE {

| | | | |
|---|---|---|---|
| rsrp-DistanceThresh | RSRP-Range | OPTIONAL, | -- Need R |
| delta-RSRP-DistanceThresh | ENUMERATED {xx..yy} | OPTIONAL, | -- Need R |
| ta-DistanceThresh | INTEGER(xx..yy) | OPTIONAL, | -- Need R |

| | | |
|---|---|---|
| nonCriticalExtension | OCTET STRING | OPTIONAL, |

...
}
-- TAG-SIB19-STOP
-- ASN1STOP

In some other embodiments, the RRC release message indicating the second configuration in 3GPP documents may be as follows:

```
-  RRCRelease
The RRCRelease message is used to command the release of an RRC connection or the suspension of the
RRC connection.
  1> Signalling radio bearer: SRB1
  2> RLC-SAP: AM
  3> Logical channel: DCCH
  4> Direction: Network to UE
RRCRelease message
-- ASN1START
-- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| RRCRelease-IEs ::= | SEQUENCE { | | |
|---|---|---|---|
| redirectedCarrierInfo | RedirectedCarrierInfo | OPTIONAL, | -- Need N |
| cellReselectionPriorities | CellReselectionPriorities | OPTIONAL, | -- Need R |

| | | |
|---|---|---|
| suspendConfig | SuspendConfig OPTIONAL, | -- Need R |

| | |
|---|---|
| deprioritisationReq | SEQUENCE { |
| deprioritisationType | ENUMERATED {frequency, nr}, |
| deprioritisationTimer | ENUMERATED {min5, min10, min15, min30} |

}
OPTIONAL, -- Need N

| | | |
|---|---|---|
| lateNonCriticalExtension | OCTET STRING | OPTIONAL, |
| nonCriticalExtension | RRCRelease-v1540-IEs | OPTIONAL |

}

| RRCRelease-v1540-IEs ::= | SEQUENCE { | |
|---|---|---|
| waitTime | RejectWaitTime | OPTIONAL, -- Need N |
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, -- Need N |

| | | |
|---|---|---|
| measIdleConfig-r16 | SetupRelease {MeasIdleConfigDedicated-r16} | OPTIONAL, |

-- Need M

| | | |
|---|---|---|
| nonCriticalExtension | RRCRelease-v1650-IEs | OPTIONAL |

}

| | | |
|---|---|---|
| RRCRelease-v1650-IEs ::= | SEQUENCE { | OPTIONAL, -- Cond |

| | |
|---|---|
| mpsPriorityIndication-r16 | ENUMERATED {true} |

Redirection2

| | | |
|---|---|---|
| nonCriticalExtension | RRCRelease-v1710-IEs | OPTIONAL |

}

| RRCRelease-v1710-IEs ::= | SEQUENCE { | | |
|---|---|---|---|
| noLastCellUpdate-r17 | ENUMERATED {true} | OPTIONAL, | -- Need S |

| | | |
|---|---|---|
| nonCriticalExtension | RRCRelease-v18xy-IEs | OPTIONAL |

}

| RRCRelease-v18xy-IEs ::= | SEQUENCE { | |
|---|---|---|
| referenceLocationInfo-r18 | referenceLocationInfo-v18xy-IEs | OPTIONAL, |
| nonCriticalExtension | SEQUENCE { } | OPTIONAL |

}

| RRCRelease-v1710-IEs ::= | SEQUENCE { | | |
|---|---|---|---|
| noLastCellUpdate-r17 | ENUMERATED {true} | OPTIONAL, | -- Need S |

| | | |
|---|---|---|
| nonCriticalExtension | RRCRelease-v18xy-IEs | OPTIONAL |

}

| RRCRelease-v18xy-IEs ::= | SEQUENCE { | |
|---|---|---|
| distanceThreshConfig-r18 | distanceThreshConfig-v18xy-IEs | OPTIONAL, |
| nonCriticalExtension | SEQUENCE { } | OPTIONAL |

}
...

| distanceThreshConfig-v18xy-IEs ::= | SEQUENCE { | | |
|---|---|---|---|
| rsrp-DistanceThresh | RSRP-Range | OPTIONAL, | -- Need R |
| delta-RSRP-DistanceThresh | ENUMERATED {xx..yy} | OPTIONAL, | -- Need R |
| ta-DistanceThresh | INTEGER(xx..yy) | OPTIONAL, | -- Need R |

| | | |
|---|---|---|
| nonCriticalExtension | OCTET STRING | OPTIONAL, |

...
}
-- TAG-SIB19-STOP
-- ASN1STOP

### Solution 3

In this solution, in addition to the cell stop serving time which is broadcasted in the SIB such as SIB19, which may be referred to as: t-Service, the serving RAN node may further indicate a third configuration associated with the cell stop serving time value of a moving cell. The third configuration may be indicated by an SIB, such as SIB19, or other SIBs. Attentively, the third configuration may be indicated by a dedicated signalling, such as RRC signaling. For example, when the UE transitions from the RRC_CONNECTED state to the RRC_IDLE state, the serving RAN node may indicate the third configuration in the RRC signaling, e.g. RRC release signaling. The cell stop serving time value of the moving cell may be represented as: tServiceInfo-v18xy-IEs, and the third configuration may include at least one of the following:
1. one or more additional cell stop serving time values;
2. one or more time offsets associated with the cell stop serving time value;
3. a third indication indicating the cell stop serving time value is variable; or
4. a cell stop serving time threshold.

Regarding the one or more additional cell stop serving time values (which may be represented as: t-Service1, t-Service2, . . . ), each additional cell stop serving time value may be associated with a condition. In the case that an associated condition is fulfilled, the UE may determine the UE-specific cell stop serving time value of the moving cell as the additional cell stop serving time value whose associated condition being fulfilled.

Specifically, for the first additional cell stop serving time value, i.e. t-Service), the condition may be associated with at least one of the following:
i. an area (which may be represented as: area-Tservice1); the condition may include: whether the location of the UE is within the area or not;
ii. an angle (which may be represented as: angle-Tservice1), which may be an elevation angle between the UE and the RAN node (e.g. a satellite), other types of angles may also be used; the condition may include: whether the current angle of the UE is equal to (larger than, smaller than, not larger than, or not smaller than, etc.) the angle or not;
iii. an RSRP value (which may be represented as: rsrp-Tservice1); the condition may include: whether the current RSRP value of the moving cell is equal to (larger than, smaller than, not larger than, or not smaller than, etc.) the RSRP value or not;
iv. an area range (which may be represented as: area-Tservice1); the condition may include: whether the location of the UE is within the area range or not;
v. an angle range (which may be represented as: angle-Tservice1); the condition may include: whether the current angle of the UE is within the angle range or not; or
vi. an RSRP value range (which may be represented as: rsrp-Tservice1); the condition may include: whether the current RSRP value of the moving cell is within the RSRP value range or not.

In some other cases, the condition may be associated with more than one parameter. For example, the condition may be associated with an area and an angle, in this case, the condition may include: condition 1) whether the location of the UE is within the area or not; and condition 2) whether the current angle of the UE is equal to (larger than, smaller than, not larger than, or not smaller than, etc.) the angle or not. That is, only when both condition 1) and condition 2) are fulfilled, the condition is considered as fulfilled. Alternatively, the condition may include: condition 1) whether the location of the UE is within the area or not; or condition 2) whether the current angle of the UE is equal to (larger than, smaller than, not larger than, or not smaller than, etc.) the angle or not. That is, when one of condition 1) and condition 2) is fulfilled, the condition is considered as fulfilled. The condition associated with other number of parameters may be applied similarly.

Regarding the one or more offsets (which may be represented as: offset1-Tservice, offset2-Tservice, . . . ), each offset may be associated with a condition. In the case that the associated condition is fulfilled, the UE may apply the corresponding offset to the cell stop serving time value, and determine the UE-specific cell stop serving time value of the moving cell as the cell stop serving time value of the moving cell (which may be broadcasted in the SIB) with the corresponding offset.

For the first offset, i.e. offset1-Tservice, the condition may be associated with at least one of the following:
i. an area (which may be represented as: area-Tservice1); the condition may include: whether the location of the UE is within the area or not;
ii. an angle (which may be represented as: angle-Tservice1), which may be an elevation angle between the UE and the RAN node (e.g. a satellite), other types of angles may also be used; the condition may include: whether the current angle of the UE is equal to (larger than, smaller than, not larger than, or not smaller than, etc.) the angle or not;
iii. an RSRP value (which may be represented as: rsrp-Tservice1); the condition may include: whether the current RSRP value of the moving cell is equal to (larger than, smaller than, not larger than, or not smaller than, etc.) the RSRP value or not;
iv. an area range (which may be represented as: area-Tservice1); the condition may include: whether the location of the UE is within the area range or not;
v. an angle range (which may be represented as: angle-Tservice1); the condition may include: whether the current angle of the UE is within the angle range or not; or
vi. an RSRP value range (which may be represented as: rsrp-Tservice1); the condition may include: whether the current RSRP value of the moving cell is within the RSRP value range or not.

In some other cases, the condition may be associated with more than one parameter. For example, the condition may be associated with an area and an angle, in this case, the condition may include: condition 1) whether the location of the UE is within the area or not; and condition 2) whether the current angle of the UE is equal to (larger than, smaller than, not larger than, or not smaller than, etc.) the angle or not. That is, only when both condition 1) and condition 2) are fulfilled, the condition is considered as fulfilled. Alternatively, the condition may include: condition 1) whether the location of the UE is within the area or not; or condition 2) whether the current angle of the UE is equal to (larger than, smaller than, not larger than, or not smaller than, etc.) the angle or not. The condition associated with other number of parameters may be applied similarly.

Regarding the third indication indicating the cell stop serving time value is variable (the third indication may be represented as: tServiceChange), the UE may determine that the serving cell is a moving cell, and may determine the UE-specific cell stop serving time value based on UE implementation.

Regarding the cell stop serving time threshold (which may be represented as: ServiceThresh). Based on cell stop serving time threshold, the UE may determine the UE-specific cell stop serving time based on a RTT value between the UE and an RAN node, the timing advance or the UE-specific timing advance (the timing advance or the UE-specific timing advance may be calculated by the UE or maintained by the UE).

Based on the third configuration, the UE may perform at least one of the following:
determine that the serving cell is a moving cell, for example, an earth-moving cell, an NTN earth-moving cell, or the like;
determine the UE-specific stop serving time value as one of the one or more additional cell-specific stop serving time values based on the associated condition;
determine the UE-specific stop serving time value by applying one of the one or more time offsets to the cell stop serving time value based on the associated condition;
determine the UE-specific stop serving time value based on the cell stop serving time value and cell coverage information of the moving cell. The coverage information of the moving cell may include: an ellipse radius (represented as: ellipsoid-Point) or a minimum angle (which may be represented as: minElevationAngle); or
determine the UE-specific stop serving time value in response to a RTT between the UE and an RAN node being larger than the cell stop serving time threshold. Specifically, the UE may consider the cell stop serving time as the time when the RTT value between the UE and the RAN node, the timing advance, or the UE-specific timing advance (the timing advance or the UE-specific timing advance may be calculated by the UE or maintained by the UE), is larger than the time threshold (i.e. tServiceThresh).

In some embodiments, an example of SIB 19 indicating the third configuration in 3GPP specification may be as follows:

3GPP TS38.331
- SIB19
SIB19 contains satellite assistance information.
SIB19 information element
-- ASN1START
-- TAG-SIB19-START
SIB19-r17 ::= SEQUENCE {

| | | | |
|---|---|---|---|
| ntn-Config-r17 | NTN-Config-r17 | OPTIONAL, | -- Need R |
| t-Service-r17 | INTEGER (0..549755813887) | OPTIONAL, | -- Need R |
| referenceLocation-r17 | ReferenceLocation-r17 | OPTIONAL, | -- Need R |
| distanceThresh-r17 | INTEGER(0..65525) | OPTIONAL, | -- Need R |
| ntn-NeighCellConfigList-r17 | NTN-NeighCellConfigList-r17 | OPTIONAL, | -- Need R |

| | | |
|---|---|---|
| lateNonCriticalExtension | OCTET STRING | OPTIONAL, |
| nonCriticalExtension | tServiceInfo-v18xy-IEs | OPTIONAL, |

...
}

| | | | |
|---|---|---|---|
| NTN-NeighCellConfigList-r17 | ::= SEQUENCE | (SIZE(1..maxCellNTN-r17)) | OF |

NTN-NeighCellConfig-r17

| NTN-NeighCellConfig-r17 ::= | SEQUENCE { | | |
|---|---|---|---|
| ntn-Config-r17 | NTN-Config-r17 | OPTIONAL, | -- Need R |
| carrierFreq-r17 | ARFCN-ValueNR | OPTIONAL, | -- Need R |
| physCellId-r17 | PhysCellId | OPTIONAL | -- Need R |

}
//Option3-1//
tServiceInfo-v18xy-IEs ::= SEQUENCE {

| | | | |
|---|---|---|---|
| t-Service1 | INTEGER (0..549755813887) | OPTIONAL, | -- Need R |
| area-Tservice1 | OCTET STRING | OPTIONAL, | -- Need R |
| angle-Tservice1 | INTEGER(xx..yy) | OPTIONAL, | -- Need R |
| rsrp-Tservice1 | RSRP-Range | OPTIONAL, | -- Need R |
| t-Service2 | INTEGER (0..549755813887) | OPTIONAL, | -- Need R |
| area-Tservice2 | OCTET STRING | OPTIONAL, | -- Need R |
| angle-Tservice2 | INTEGER(xx..yy) | OPTIONAL, | -- Need R |
| rsrp-Tservice2 | RSRP-Range | OPTIONAL, | -- Need R |

| | | |
|---|---|---|
| nonCriticalExtension | OCTET STRING | OPTIONAL, |

...
}
//Option3-2//

| tServiceInfo-v18xy-IEs ::= | SEQUENCE { | | |
|---|---|---|---|
| offset1-Tservice | OCTET STRING | OPTIONAL, | -- Need R |
| area-Offset1-Tservice | OCTET STRING | OPTIONAL, | -- Need R |
| angle-Offset1-Tservice | INTEGER(xx..yy) | OPTIONAL, | -- Need R |
| rsrp-Offset1-Tservice | RSRP-Range | OPTIONAL, | -- Need R |
| offset2-Tservice | OCTET STRING | OPTIONAL, | -- Need R |
| area-Offset2-Tservice | OCTET STRING | OPTIONAL, | -- Need R |
| angle-Offset2-Tservice | INTEGER(xx..yy) | OPTIONAL, | -- Need R |
| rsrp-Offset2-Tservice | RSRP-Range | OPTIONAL, | -- Need R |

| | | |
|---|---|---|
| nonCriticalExtension | OCTET STRING | OPTIONAL, |

...
}
//Option3-3//
tServiceInfo-v18xy-IEs ::= SEQUENCE {

| | | | |
|---|---|---|---|
| tServiceChange | BOOLEAN | OPTIONAL, | -- Need R |
| ellipsoid-Point-r10 | OCTET STRING | OPTIONAL, | -- Need R |
| minElevationAngle | INTEGER(xx..yy) | OPTIONAL, | -- Need R |

| | | |
|---|---|---|
| nonCriticalExtension | OCTET STRING | OPTIONAL, |

...
}
//Option3-4//
tServiceInfo-v18xy-IEs ::= SEQUENCE {

| | | | |
|---|---|---|---|
| tServiceThresh | INTEGER(xx..yy) | OPTIONAL, | -- Need R |

| | | |
|---|---|---|
| nonCriticalExtension | OCTET STRING | OPTIONAL, |

```
...
}
-- TAG-SIB19-STOP
-- ASN1STOP
RRCRelease
The RRCRelease message is used to command the release of an RRC connection or the suspension of the
RRC connection.
  1> Signalling radio bearer: SRB1
  2> RLC-SAP: AM
  3> Logical channel: DCCH
  4> Direction: Network to UE
RRCRelease message
-- ASN1START
-- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| RRCRelease-IEs ::= | SEQUENCE { | | |
|---|---|---|---|
| redirectedCarrierInfo | RedirectedCarrierInfo | OPTIONAL, | -- Need N |
| cellReselectionPriorities | CellReselectionPriorities | OPTIONAL, | -- Need R |

| | |
|---|---|
| suspendConfig | SuspendConfig OPTIONAL, -- Need R |
| deprioritisationReq | SEQUENCE { |
| deprioritisationType | ENUMERATED {frequency, nr}, |
| deprioritisationTimer | ENUMERATED {min5, min10, min15, min30} |

}
OPTIONAL, -- Need N

| | | |
|---|---|---|
| lateNonCriticalExtension | OCTET STRING | OPTIONAL, |
| nonCriticalExtension | RRCRelease-v1540-IEs | OPTIONAL |

}

| RRCRelease-v1540-IEs ::= | SEQUENCE { | | |
|---|---|---|---|
| waitTime | RejectWaitTime | OPTIONAL, | -- Need N |

| | | |
|---|---|---|
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, -- Need N |

| | | |
|---|---|---|
| measIdleConfig-r16 | SetupRelease {MeasIdleConfigDedicated-r16} | OPTIONAL, |

-- Need M

| | | |
|---|---|---|
| nonCriticalExtension | RRCRelease-v1650-IEs | OPTIONAL |

}

| | | |
|---|---|---|
| RRCRelease-v1650-IEs ::= | SEQUENCE { | OPTIONAL, -- Cond |

| | |
|---|---|
| mpsPriorityIndication-r16 | ENUMERATED {true} |

Redirection2

| | | |
|---|---|---|
| nonCriticalExtension | RRCRelease-v1710-IEs | OPTIONAL |

}

| RRCRelease-v1710-IEs ::= | SEQUENCE { | |
|---|---|---|
| noLastCellUpdate-r17 | ENUMERATED {true} | OPTIONAL, -- Need S |
| nonCriticalExtension | RRCRelease-v18xy-IEs | OPTIONAL |

}

| RRCRelease-v18xy-IEs ::= | SEQUENCE { | |
|---|---|---|
| tServiceInfo-r18 | tServiceInfo-v18xy-IEs | OPTIONAL, |
| nonCriticalExtension | SEQUENCE { } | OPTIONAL |

}
...
//Option3-1//

| tServiceInfo-v18xy-IEs ::= | SEQUENCE { | | |
|---|---|---|---|
| t-Service1 | INTEGER (0..549755813887) | OPTIONAL, | -- Need R |
| area-Tservice1 | OCTET STRING | OPTIONAL, | -- Need R |
| angle-Tservice1 | INTEGER(xx..yy) | OPTIONAL, | -- Need R |
| rsrp-Tservice1 | RSRP-Range | OPTIONAL, | -- Need R |
| t-Service2 | INTEGER (0..549755813887) | OPTIONAL, | -- Need R |
| area-Tservice2 | OCTET STRING | OPTIONAL, | -- Need R |
| angle-Tservice2 | INTEGER(xx..yy) | OPTIONAL, | -- Need R |
| rsrp-Tservice2 | RSRP-Range | OPTIONAL, | -- Need R |

| | | |
|---|---|---|
| nonCriticalExtension | OCTET STRING | OPTIONAL, |

...
}
//Option3-2//

| tServiceInfo-v18xy-IEs ::= | SEQUENCE { | | |
|---|---|---|---|
| offset1-Tservice | OCTET STRING | OPTIONAL, | -- Need R |
| area-Offset1-Tservice | OCTET STRING | OPTIONAL, | -- Need R |
| angle-Offset1-Tservice | INTEGER(xx..yy) | OPTIONAL, | -- Need R |
| rsrp-Offset1-Tservice | RSRP-Range | OPTIONAL, | -- Need R |
| offset2-Tservice | OCTET STRING | OPTIONAL, | -- Need R |
| area-Offset2-Tservice | OCTET STRING | OPTIONAL, | -- Need R |
| angle-Offset2-Tservice | INTEGER(xx..yy) | OPTIONAL, | -- Need R |
| rsrp-Offset2-Tservice | RSRP-Range | OPTIONAL, | -- Need R |

| | | |
|---|---|---|
| nonCriticalExtension | OCTET STRING | OPTIONAL, |

...
}
//Option3-3//

| tServiceInfo-v18xy-IEs ::= | SEQUENCE { | | |
|---|---|---|---|
| tServiceChange | BOOLEAN | OPTIONAL, | -- Need R |
| ellipsoid-Point-r10 | OCTET STRING | OPTIONAL, | -- Need R |
| minElevationAngle | INTEGER(xx..yy) | OPTIONAL, | -- Need R |

| | | |
|---|---|---|
| nonCriticalExtension | OCTET STRING | OPTIONAL, |

...
}
//Option3-4//

| tServiceInfo-v18xy-IEs ::= | SEQUENCE { | | |
|---|---|---|---|
| tServiceThresh | INTEGER(xx..yy) | OPTIONAL, | -- Need R |

| | | |
|---|---|---|
| nonCriticalExtension | OCTET STRING | OPTIONAL, |

...
}
-- TAG-SIB19-STOP
-- ASN1STOP

In some other embodiments, the RRC release message indicating the third configuration in 3GPP documents may be as follows:

### Solution 4

In this solution, the serving RAN node may indicate a fourth configuration associated with a feeder link switch time value to the UE, to indicate the cell-specific feeder link switch time for a moving cell (which may be represented as: t-FeederLinkChange-18xy-IEs). The fourth configuration may be indicated by an SIB, such as SIB19, or other SIBs. Alternatively, the fourth configuration may be indicated by a dedicated signalling, such as RRC signaling. For example, when the UE transitions from the RRC_CONNECTED state to the RRC_IDLE state, the serving RAN node may indicate the fourth configuration in the RRC signaling, e.g. RRC release signaling.

The fourth configuration may include an IE indicating the feeder link switch time value of the moving cell (which may be represented as: t-FLchange). The IE (the cell stop serving time value, i.e. t-Service) for indicating the cell stop serving time may also be transmitted to the UE. In some other embodiments, the IE, t-Service, may be reused for indicating the feeder link switch time value of the moving cell, in this case, the serving RAN node may not indicate the cell stop serving time value to the UE, and the UE may determine (or derive) the cell stop serving time value based on the cell coverage information. The determined cell stop serving time value may be referred to as UE-specific or location-specific cell stop serving time value.

Based on the fourth configuration, the UE may determine two different time values: 1) the feeder link switch time value of the moving cell, and 2) the UE-specific or location-specific cell stop serving time value of the moving cell.

The UE may consider the earlier one of the two time values as the UE-specific or location-specific cell stop serving time. More specifically, in the case that the feeder link switch time value is earlier than the UE-specific or location-specific stop serving time applied or derived by the UE, the UE may consider the feeder link switch time as the time when the cell stops serving; in the case that the feeder link switch time indicated by network is later than the UE-specific or location-specific stop serving time applied or derived by the UE, the UE may consider the UE-specific or location-specific cell stop serving time as the time when the cell stops serving.

The UE then may perform intra-frequency measurements, inter-frequency measurements, or inter-RAT measurements before the time the cell stops serving.

In some embodiments, an example of SIB 19 indicating the fourth configuration in 3GPP specification may be as follows:

3GPP TS38.331
- SIB19
SIB19 contains satellite assistance information.
SIB19 information element
-- ASN1START
-- TAG-SIB19-START
SIB19-r17 ::= SEQUENCE {

| | | | |
|---|---|---|---|
| ntn-Config-r17 | NTN-Config-r17 | OPTIONAL, | -- Need R |
| t-Service-r17 | INTEGER (0..549755813887) | OPTIONAL, | -- Need R |
| referenceLocation-r17 | ReferenceLocation-r17 | OPTIONAL, | -- Need R |
| distanceThresh-r17 | INTEGER(0..65525) | OPTIONAL, | -- Need R |
| ntn-NeighCellConfigList-r17 | NTN-NeighCellConfigList-r17 | OPTIONAL, | -- Need R |

| | | |
|---|---|---|
| lateNonCriticalExtension | OCTET STRING | OPTIONAL, |
| nonCriticalExtension | t-FeederLinkChange-v18xy-IEs | OPTIONAL, |

...
}

| | | | |
|---|---|---|---|
| NTN-NeighCellConfigList-r17 | ::= SEQUENCE | (SIZE(1..maxCellNTN-r17)) | OF |

NTN-NeighCellConfig-r17

| NTN-NeighCellConfig-r17 ::= | SEQUENCE { | | |
|---|---|---|---|
| ntn-Config-r17 | NTN-Config-r17 | OPTIONAL, | -- Need R |
| carrierFreq-r17 | ARFCN-ValueNR | OPTIONAL, | -- Need R |
| physCellId-r17 | PhysCellId | OPTIONAL | -- Need R |

}
t-FeederLinkChange-v18xy-IEs ::= SEQUENCE {

| | | | |
|---|---|---|---|
| t-FeederLinkChange | INTEGER (0..549755813887) | OPTIONAL, | -- Need R |

| | | |
|---|---|---|
| nonCriticalExtension | OCTET STRING | OPTIONAL, |

...
}
-- TAG-SIB19-STOP
-- ASN1STOP

In some other embodiments, the RRC release message indicating the fourth configuration in 3GPP documents may be as follows:

```
RRCRelease
The RRCRelease message is used to command the release of an RRC connection or the suspension of the
RRC connection.
  5> Signalling radio bearer: SRB1
  6> RLC-SAP: AM
  7> Logical channel: DCCH
  8> Direction: Network to UE
RRCRelease message
-- ASN1START
-- TAG-RRCRELEASE-START
```

| | |
|---|---|
| RRCRelease ::= | SEQUENCE { |
| rrc-TransactionIdentifier | RRC-TransactionIdentifier, |
| criticalExtensions | CHOICE { |
| rrcRelease | RRCRelease-IEs, |
| criticalExtensionsFuture | SEQUENCE { } |

}
}

| RRCRelease-IEs ::= | SEQUENCE { | |
|---|---|---|
| redirectedCarrierInfo | RedirectedCarrierInfo | OPTIONAL, -- Need N |
| cellReselectionPriorities | CellReselectionPriorities | OPTIONAL, -- Need R |
| suspendConfig | SuspendConfig OPTIONAL, | -- Need R |

| | |
|---|---|
| deprioritisationReq | SEQUENCE { |
| deprioritisationType | ENUMERATED {frequency, nr}, |
| deprioritisationTimer | ENUMERATED {min5, min10, min15, min30} |

}
OPTIONAL, -- Need N

| | | |
|---|---|---|
| lateNonCriticalExtension | OCTET STRING | OPTIONAL, |
| nonCriticalExtension | RRCRelease-v1540-IEs | OPTIONAL |

}

| RRCRelease-v1540-IEs ::= | SEQUENCE { | |
|---|---|---|
| waitTime | RejectWaitTime | OPTIONAL, -- Need N |
| nonCriticalExtension | RRCRelease-v1610-IEs | OPTIONAL |

}

| RRCRelease-v1610-IEs ::= | SEQUENCE { | |
|---|---|---|
| voiceFallbackIndication-r16 | ENUMERATED {true} | OPTIONAL, -- Need N |

| | |
|---|---|
| measIdleConfig-r16 | SetupRelease {MeasIdleConfigDedicated-r16} OPTIONAL, |

-- Need M

| | | |
|---|---|---|
| nonCriticalExtension | RRCRelease-v1650-IEs | OPTIONAL |

}

| RRCRelease-v1650-IEs ::= | SEQUENCE { | |
|---|---|---|
| mpsPriorityIndication-r16 | ENUMERATED {true} | OPTIONAL, -- Cond |

Redirection2

| | | |
|---|---|---|
| nonCriticalExtension | RRCRelease-v1710-IEs | OPTIONAL |

}

| RRCRelease-v1710-IEs ::= | SEQUENCE { | |
|---|---|---|
| noLastCellUpdate-r17 | ENUMERATED {true} | OPTIONAL, -- Need S |
| nonCriticalExtension | RRCRelease-v18xy-IEs | OPTIONAL |

}

| RRCRelease-v18xy-IEs ::= | SEQUENCE { | |
|---|---|---|
| t-FeederLinkChange-r18 | t-FeederLinkChange-v18xy-IEs | OPTIONAL, |
| nonCriticalExtension | SEQUENCE { } | |
| | | OPTIONAL |

}
...
t-FeederLinkChange-v18xy-IEs ::= SEQUENCE {

| | | |
|---|---|---|
| t-FeederLinkChange | INTEGER (0..549755813887) | OPTIONAL, -- Need R |
| nonCriticalExtension | OCTET STRING | OPTIONAL, |

...
}
-- TAG-SIB19-STOP
-- ASN1STOP

It should be noted that the above expressions, such as “referenceLocationInfo,” “referenceLocation1,” “t-ReferenceLocation1,” “offset1-ReferenceLocation,” “referenceLocationChange,” etc., are just exemplary and explanatory, and other expressions may also be applied in the present disclosure.

FIG. 3 illustrates a method performed by a UE for mobility enhancements according to some embodiments of the present disclosure.

In operation 301, the UE may receive a message associated with a moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value.

In operation 302, the UE may determine the cell reference location of the moving cell or a UE-specific stop serving time value based on the message.

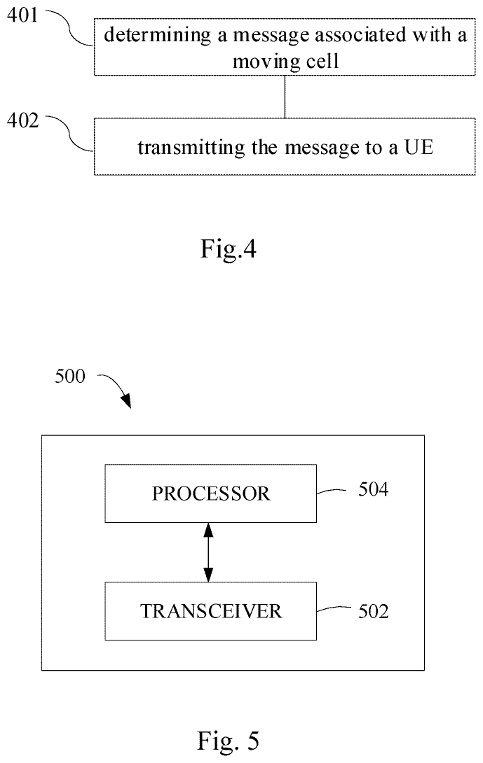

FIG. 4 illustrates a method performed by an RAN node for mobility enhancements according to some embodiments of the present disclosure.

In operation 401, the RAN node may determine a message associated with a moving cell, wherein the message indicates at least one of the following: a first configuration associated with a cell reference location; a second configuration associated with distance metric evaluation; a third configuration associated with a cell stop serving time value; or a fourth configuration associated with a feeder link switch time value. In operation 402, the RAN node may transmit the message to a UE.

In some embodiments, the first configuration may include at least one of the following: movement information of the cell reference location; one or more additional cell reference locations; one or more location offsets associated with the cell reference location; a first indication indicating the cell reference location is variable; or a second indication indicating a reference location of an RAN node associated with the moving cell.

In some embodiments, the movement information of the cell reference location includes at least one of the following: a velocity of the cell reference location; a first epoch time value associated with the velocity of the cell reference location; a first validity duration associated with the velocity of the cell reference location; a variation vector of the velocity of the cell reference location; a second epoch time value associated with the variation vector of the velocity of the cell reference location; or a second validity duration associated with the variation vector of the velocity of the cell reference location. In some cases, the first epoch time value and the second epoch time value may be the same, and the first validity duration and the second validity duration may also be the same.

In some embodiments, each of the one or more additional cell reference locations or each of one or more location offsets is associated with at least one of the following: a time value; an area; an angle; a RSRP value; a time value range; an area range; an angle range; or an RSRP value range.

In some embodiments, the UE may perform at least one of the following: determine the cell reference location based on the movement information of the cell reference location; determine the cell reference location as one of the one or more additional cell reference locations; determine the cell reference location by applying one of the one or more location offsets to the cell reference location; determine the cell reference location based on ephemeris of an RAN node; or determine the cell reference location as the reference location of the RAN node based on the second indication.

In some embodiments, the second configuration includes at least one of the following: a RSRP threshold; an RSRP variation threshold; or a time threshold.

In some embodiments, the UE may perform at least one of the following: calculate a distance between the UE and the cell reference location; calculate the distance between the UE and the cell reference location in response to an RSRP value being lower than the RSRP threshold; calculate the distance between the UE and the cell reference location in response to an RSRP variation being lower than the RSRP variation threshold; calculate the distance between the UE and the cell reference location in response to a RTT value between the UE and an RAN node being larger than the time threshold; evaluate whether the distance between the UE and the cell reference location is shorter than a distance threshold; evaluate whether the distance between the UE and the cell reference location is shorter than the distance threshold in response to the RSRP value being lower than the RSRP threshold; evaluate whether the distance between the UE and the cell reference location is shorter than the distance threshold in response to the RSRP variation being lower than the RSRP variation threshold; or evaluate whether the distance between the UE and the cell reference location is shorter than the distance threshold in response to the RTT value between the UE and an RAN node being larger than the time threshold.

In some embodiments, the third configuration includes at least one of the following: one or more additional cell stop serving time values; one or more time offsets associated with the cell stop serving time value; a third indication indicating the cell stop serving time value is variable; or a cell stop serving time threshold.

In some embodiments, each of the one or more additional cell stop serving time values or each of the one or more time offsets associated with the cell stop serving time value is associated with at least one of the following: an area; an angle; an RSRP value; an area range; an angle range; or an RSRP value range.

In some embodiments, the UE may perform at least one of the following: determine the UE-specific stop serving time value as one of the one or more additional cell stop serving time values; determine the UE-specific stop serving time value by applying one of the one or more time offsets to the cell stop serving time value; determine the UE-specific stop serving time value based on the cell stop serving time value and cell coverage information of the moving cell; or determine the UE-specific stop serving time value in response to a RTT between the UE and an RAN node being larger than the cell stop serving time threshold.

In some embodiments, the fourth configuration includes an IE indicating the feeder link switch time value of the moving cell.

In some embodiments, the UE may determine the UE-specific stop serving time value as an earlier one of the feeder link switch time value or the cell stop serving time value.

In some embodiments, the message includes a system information message or a dedicated signalling. For example, the message may be an SIB, or RRC Release message.

In some embodiments, the UE may evaluate whether to perform a neighbour cell measurement procedure for cell selection or cell reselection based on the message.

For example, the UE may evaluate whether to perform a neighbour cell measurement procedure for cell selection or cell reselection based on the distance between the UE and the cell reference location, or based on the UE-specific cell stop serving time.

FIG. 5 illustrates a simplified block diagram of an apparatus according to some embodiments of the present disclosure.

As shown in FIG. 5, an example of the apparatus 500 may include at least one processor 504 and at least one transceiver 502 coupled to the processor 504. The apparatus 500 may be a UE, a BS, an RAN node, or any other device with similar functions.

Although in this figure, elements such as the at least one transceiver 502 and processor 504 are described in the singular, the plural is contemplated unless a limitation to the singular is explicitly stated. In some embodiments of the present disclosure, the transceiver 502 may be divided into two devices, such as a receiving circuitry and a transmitting circuitry. In some embodiments of the present disclosure, the apparatus 500 may further include an input device, a memory, and/or other components.

In some embodiments of the present disclosure, the apparatus 500 may be a UE. The transceiver 502 and the processor 504 may interact with each other so as to perform the operations of the UE described in any of FIGS. 1-4. In some embodiments of the present disclosure, the apparatus 500 may be an RAN node. The transceiver 502 and the processor 504 may interact with each other so as to perform the operations of the RAN node described in any of FIGS. 1-4.

In some embodiments of the present disclosure, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations of the UE described in any of FIGS. 1-4.

In some embodiments of the present disclosure, the non-transitory computer-readable medium may have stored thereon computer-executable instructions to cause the processor 504 to implement the method with respect to the RAN node as described above. For example, the computer-executable instructions, when executed, cause the processor 504 interacting with transceiver 502 to perform the operations of the RAN node described in any of FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a message associated with a moving cell, wherein the message indicates at least one of:
a first configuration associated with a cell reference location;
a second configuration associated with distance metric evaluation; or
a third configuration associated with a feeder link switch time value;
determine the cell reference location of the moving cell based on the message.

2. The UE of claim 1, wherein the first configuration includes at least one of:
movement information of the cell reference location;
one or more additional cell reference locations; or
an indication indicating the cell reference location is variable.

3. The UE of claim 2, wherein the movement information of the cell reference location includes at least one of:
a velocity of the cell reference location;
a first epoch time value associated with the velocity of the cell reference location;
a first validity duration associated with the velocity of the cell reference location;
a variation vector of the velocity of the cell reference location;
a second epoch time value associated with the variation vector of the velocity of the cell reference location; or
a second validity duration associated with the variation vector of the velocity of the cell reference location.

4. The UE of claim 2, wherein each of the one or more additional cell reference locations is associated with a time value.

5. The UE of claim 2, wherein the at least one processor is further configured to cause the UE to:
determine the cell reference location based on ephemeris of a radio access network (RAN) node.

6. The UE of claim 1, wherein the at least one processor is further configured to cause the UE to at least one of:
calculate a distance between the UE and the cell reference location;
calculate the distance between the UE and the cell reference location in response to a reference signal receiving power (RSRP) value being lower than an RSRP threshold;
calculate the distance between the UE and the cell reference location in response to an RSRP variation being lower than an RSRP variation threshold;
calculate the distance between the UE and the cell reference location in response to a round-trip time (RTT) value between the UE and a radio access network (RAN) node being larger than a time threshold;
evaluate whether the distance between the UE and the cell reference location is shorter than a distance threshold;
evaluate whether the distance between the UE and the cell reference location is shorter than the distance threshold in response to the RSRP value being lower than the RSRP threshold;
evaluate whether the distance between the UE and the cell reference location is shorter than the distance threshold in response to the RSRP variation being lower than the RSRP variation threshold; or
evaluate whether the distance between the UE and the cell reference location is shorter than the distance threshold in response to the RTT value between the UE and the RAN node being larger than the time threshold.

7. The UE of claim 1, wherein the message indicates a fourth configuration that includes at least one of:
a cell stop serving time value;
one or more additional cell stop serving time values;
one or more time offsets associated with the cell stop serving time value;
an indication indicating the cell stop serving time value is variable; or
a cell stop serving time threshold.

8. The UE of claim 7, wherein each of the one or more additional cell stop serving time values or each of the one or more time offsets associated with the cell stop serving time value is associated with at least one of:
an area;
an angle;
a reference signal receiving power (RSRP) value;
an area range;
an angle range; or
an RSRP value range.

9. The UE of claim 7, wherein the at least one processor is further configured to cause the UE to at least one of:
determine a UE-specific stop serving time value as one of the one or more additional cell stop serving time values;
determine the UE-specific stop serving time value by applying one of the one or more time offsets to the cell stop serving time value;
determine the UE-specific stop serving time value based on the cell stop serving time value and cell coverage information of the moving cell; or
determine the UE-specific stop serving time value in response to a round-trip time (RTT) between the UE and a radio access network (RAN) node being larger than the cell stop serving time threshold.

10. The UE of claim 1, wherein the third configuration includes an information element (IE) indicating the feeder link switch time value of the moving cell.

11. The UE of claim 10, wherein the at least one processor is further configured to cause the UE to:
determine a UE-specific stop serving time value as an earlier one of the feeder link switch time value or a cell stop serving time value.

12. A radio access network (RAN) node for wireless communication, comprising:
at least one memory; and
at least one processor coupled with the at least one memory and configured to cause the RAN node to:
determine a message associated with a moving cell, wherein the message indicates at least one of:
a first configuration associated with a cell reference location;
a second configuration associated with distance metric evaluation;
a third configuration associated with a feeder link switch time value; and
transmit the message to a user equipment (UE).

13. The RAN node of claim 12, wherein the first configuration includes at least one of:
movement information of the cell reference location;
one or more additional cell reference locations; or
an indication indicating the cell reference location is variable.

14. The RAN node of claim 13, wherein the movement information of the cell reference location includes at least one of:
a velocity of the cell reference location;
a first epoch time value associated with the velocity of the cell reference location;
a first validity duration associated with the velocity of the cell reference location;
a variation vector of the velocity of the cell reference location;
a second epoch time value associated with the variation vector of the velocity of the cell reference location; or
a second validity duration associated with the variation vector of the velocity of the cell reference location.

15. A method performed by a user equipment (UE), the method comprising:
receiving a message associated with a moving cell, wherein the message indicates at least one of:
a first configuration associated with a cell reference location;
a second configuration associated with distance metric evaluation;
a third configuration associated with a feeder link switch time value;
determining the cell reference location of the moving cell based on the message.

16. The method of claim 15, wherein the first configuration includes at least one of:
movement information of the cell reference location;
one or more additional cell reference locations; or
an indication indicating the cell reference location is variable.

17. The method of claim 16, wherein each of the one or more additional cell reference locations is associated with a time value.

18. The method of claim 15, wherein the third configuration includes an information element (IE) indicating the feeder link switch time value of the moving cell.

19. A processor for wireless communication, comprising:
at least one controller coupled with at least one memory and configured to cause the processor to:
receive a message associated with a moving cell, wherein the message indicates at least one of:
a first configuration associated with a cell reference location;
a second configuration associated with distance metric evaluation; or
a third configuration associated with a feeder link switch time value;
determine the cell reference location of the moving cell based on the message.

20. The processor of claim 19, wherein the first configuration includes at least one of:
movement information of the cell reference location;
one or more additional cell reference locations; or
an indication indicating the cell reference location is variable.
